(19) United States
(12) Patent Application Publication
(10) Pub. No.: US 2025/0077041 A1
(43) Pub. Date: Mar. 6, 2025

(54) IMAGE PROCESSING APPARATUS CAPABLE OF COMMUNICATING WITH CHAT SERVER, CONTROL METHOD THEREFOR, AND STORAGE MEDIUM

(71) Applicant: CANON KABUSHIKI KAISHA, Tokyo (JP)

(72) Inventor: CHIE ITO, Chiba (JP)

(21) Appl. No.: 18/814,304

(22) Filed: Aug. 23, 2024

(30) Foreign Application Priority Data
Aug. 31, 2023 (JP) 2023-140965

(51) Int. Cl. G06F 3/04815; G06F 3/04817; H04N 1/00

(52) U.S. Cl. CPC G06F 3/04815; G06F 3/04817; H04N 1/00212; H04N 1/00225; H04N 2201/0094

(57) ABSTRACT

An image processing apparatus having a mechanism capable of easily specifying a sharing destination of image data. In the image processing apparatus, An image of a document is read and image data is generated based on the image. Avatar information for displaying an avatar image three-dimensionally expressing a user who is a candidate for a sharing destination of the image data is acquired from the chat server. Control to display a screen for designating the sharing destination of the image data is performed. The image data to be shared with the user designated on the screen is transmitted to the chat server. The avatar image of the user who is the candidate for the sharing destination of the image data, which is an avatar image based on the acquired avatar information, is displayed on the screen in association with the user.

### BACKGROUND OF THE INVENTION

### Field of the Invention

The present invention relates to an image processing apparatus capable of communicating with a chat server, a control method for the image processing apparatus, and a storage medium.

### Description of the Related Art

With diversification of work systems, use of a virtual office, a VR conference service, and the like in metaverse spaces has increased. Furthermore, the number of companies using business chats as communication tools has increased. There are many business chats having a function of easily holding a video conference from a chat screen. At that time, it is general to display a user's own image for a user whose video is turned on and display an icon on the chat for a user whose video is turned off. In a metaverse space, characters representing users participating in the video conference, called avatars, appear in a VR conference instead of the users. At this time, the avatars make movements close to a human, and thus, appearances of the users are often reflected three-dimensionally. There is also a business chat in which avatars show faces instead of videos or icon images in a video conference on the business chat.

Furthermore, in recent years, scan-to-chat that enables image data generated by a scan to be easily shared on a business chat has been used. As a related technique, a technique in Japanese Laid-Open Patent Publication (kokai) No. 2022-13620 is proposed. In Japanese Laid-Open Patent Publication (kokai) No. 2022-13620, in an image processing apparatus including a button for executing scan-to-chat in an operation unit, an icon image on a chat of a group and/or an individual as a sharing destination is set as an image of the button. As a result, a user can easily specify the sharing destination of image data before pressing this button, and can prevent sharing of the image data with an unintended partner.

In business chats, it is often necessary to register an icon image by oneself. In the technique in Japanese Laid-Open Patent Publication (kokai) No. 2022-13620 described above, for example, a default image of a person whose sex or the like is unidentifiable is set as the image of the button for executing the scan-to-chat to share image data with a partner whose icon image is not registered. With such a default image, the user cannot specify the sharing destination of the image data.

### SUMMARY OF THE INVENTION

The present invention provides an image processing apparatus having a mechanism capable of easily specifying a sharing destination of image data, a control method therefor, and a storage medium.

Accordingly, the present invention provides an image processing apparatus capable of communicating with a chat server that performs control to share received data with a designated user, the image processing apparatus comprising at least one memory that stores a set of instructions; and at least one processor that executes the instructions, the instructions, when being executed, causing the image processing apparatus to: read an image of a document and generate image data based on the image; acquire, from the chat server, avatar information for displaying an avatar image three-dimensionally expressing a user who is a candidate for a sharing destination of the image data; perform control to display a screen for designating the sharing destination of the image data; and transmit the image data to be shared with the user designated on the screen to the chat server, wherein the avatar image of the user who is the candidate for the sharing destination of the image data, which is an avatar image based on the acquired avatar information, is displayed on the screen in association with the user.

According to the present invention, it is possible to easily specify the sharing destination of the image data in the image processing apparatus.

Further features of the present invention will become apparent from the following description of exemplary embodiments with reference to the attached drawings.

### BRIEF DESCRIPTION OF THE DRAWINGS

FIG. 1 is a diagram showing an example of a configuration of a system including an MFP as an image processing apparatus according to the present embodiment.

FIG. 2 is a block diagram schematically showing a hardware configuration of the MFP of FIG. 1.

FIG. 3 is a block diagram schematically showing a hardware configuration of a chat server of FIG. 1.

FIG. 4 is a diagram showing an example of a file structure stored in an HDD of the chat server of FIG. 1.

FIGS. 5A and 5B are diagrams showing examples of screens when a user creates his/her own avatar image.

FIG. 6 is a diagram showing a configuration example of avatar information included in the file structure of FIG. 4.

FIG. 7 is a diagram showing an example of a sequence of scan-to-chat executed by the system of FIG. 1.

FIG. 8 is a diagram showing an example of a screen displayed on an operation unit of FIG. 2.

FIGS. 9A and 9B indicate a flowchart showing a procedure of control processing performed by the MFP when the system of FIG. 1 executes the scan-to-chat.

FIG. 10 is a flowchart showing a procedure of control processing performed in the chat server when the system of FIG. 1 executes the scan-to-chat.

FIGS. 11A and 11B indicate a flowchart showing another procedure of the control processing performed in the chat server when the system of FIG. 1 executes the scan-to-chat.

FIG. 12 is a diagram showing an example of a simple login screen displayed on the operation unit of FIG. 2.

FIG. 13 is a diagram showing an example of a setting screen displayed on the operation unit of FIG. 2.

FIG. 14 is a flowchart showing a procedure of display control processing of the simple login screen performed by the MFP of FIG. 1.

### DESCRIPTION OF THE EMBODIMENTS

The present invention will now be described in detail below with reference to the accompanying drawings showing embodiments thereof. It should be noted that the following embodiments do not limit the present invention, and all combinations of features described in the embodiments are not necessarily essential to the solution of the invention.

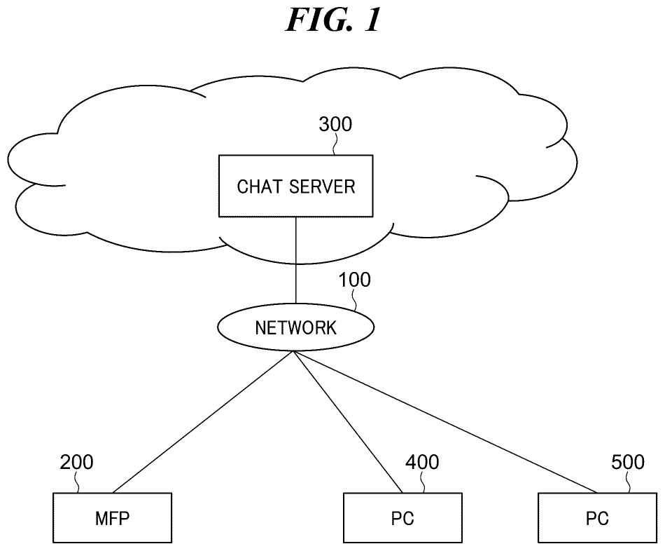

FIG. 1 is a diagram showing an example of a configuration of a system including an MFP 200 as an image processing apparatus according to the present embodiment. In FIG. 1, the system includes the MFP 200, a chat server 300, a PC 400, and a PC 500. The chat server 300 receives a message and image data transmitted from the MFP 200 and the PC 400, and provides a chat service for displaying (sharing) the received message and image data on the PC 500 or a PC (not shown) by a user operation. The MFP 200 has a function of reading an image of a document, generating image data based on the image, and transmitting the image data to the chat server 300. The MFP 200, the PC 400, the PC 500, and the chat server 300 are communicably connected via a network 100. The network 100 is a wireless or wired network including a WAN and a LAN.

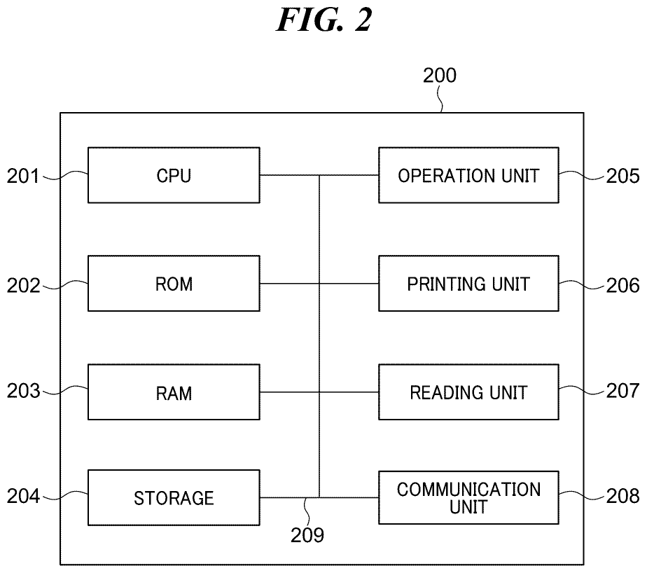

FIG. 2 is a block diagram schematically showing a hardware configuration of the MFP 200 of FIG. 1. In FIG. 2, the MFP 200 includes a CPU 201, a ROM 202, a RAM 203, a storage 204, an operation unit 205, a printing unit 206, a reading unit 207, and a communication unit 208. The CPU 201, the ROM 202, the RAM 203, the storage 204, the operation unit 205, the printing unit 206, the reading unit 207, and the communication unit 208 are connected to each other via a bus 209.

The CPU 201 controls the overall operation of the MFP 200. The CPU 201 reads a control program stored in the ROM 202 or the storage 204 into the RAM 203, and performs various types of control such as reading control and printing control.

The ROM 202 stores the control program that can be executed by the CPU 201. The RAM 203 is a main storage memory, and is used as a work area and a temporary storage area for developing the control programs stored in the ROM 202 and the storage 204. The storage 204 stores image data, print data, a program, and setting information. It should be noted that a flash memory is assumed as the storage 204 in the present embodiment, but an auxiliary storage device such as a solid state drive (SSD) or a hard disc drive (HDD) may be used as the storage 204. Furthermore, an embedded Multi Media Card (eMMC) may be used as the storage 204. Furthermore, the MFP 200 of the present embodiment has a configuration in which one CPU 201 executes each process shown in sequences to be described later using one memory (the RAM 203), but the configuration is not limited thereto. For example, a plurality of CPUs, RAMs, ROMs, and storages can be configured to cooperate with each other to execute each process shown in flowcharts to be described later. Furthermore, some processes may be executed using a hardware circuit such as an ASIC or an FPGA.

The operation unit 205 includes, for example, a display unit such as a touch panel and/or a hard key. The operation unit 205 displays information to a user and detects an input from the user. It should be noted that a configuration in which the MFP 200 includes the operation unit 205 including the display unit is described in the present embodiment, but the configuration of the MFP 200 is not limited thereto. For example, the MFP 200 may include an operation unit that does not include a display unit, and a display unit different from the operation unit may be connected to the MFP 200. In such a configuration, the CPU 201 of the MFP 200 performs display control to display various screens on the display unit.

The printing unit 206 prints image data (print data) stored in the RAM 203 on a recording sheet fed from a sheet feeding cassette (not shown). The reading unit 207 reads an image of a document, and the CPU 201 converts the image into image data such as binary data. The image data generated based on the image read by the reading unit 207 is transmitted to an external device and/or printed on the recording sheet. The communication unit 208 is connected to the network 100. The communication unit 208 transmits image data to the external device on the network 100 and receives print data from the external device. As a method for transmission and reception of various types of data via the network 100, transmission and reception using electronic mails and file transmission using other protocols (for example, FTP, SMB, WEBDAV, and the like) can be performed. Further, the communication unit 208 can also transmit and receive image data and various types of setting data via the network 100 through access by HTTP communication from the PC 500.

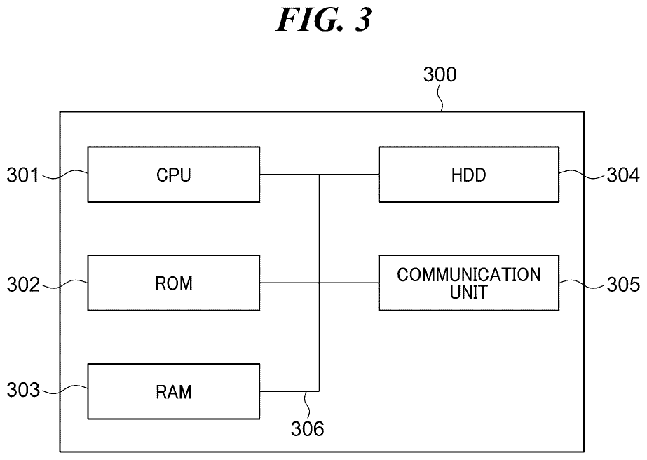

FIG. 3 is a block diagram schematically showing a hardware configuration of the chat server 300 of FIG. 1. In FIG. 3, the chat server 300 includes a CPU 301, a ROM 302, a RAM 303, an HDD 304, and a communication unit 305. The CPU 301, the ROM 302, the RAM 303, the HDD 304, and the communication unit 305 are connected to each other via a bus 306.

The CPU 301 includes an arithmetic circuit, reads a program stored in the ROM 302 or the HDD 304 into the RAM 303, and executes various types of processing. The ROM 302 stores a message processed by the chat server 300. Furthermore, the ROM 302 stores a system program and the like used to control user management and content management. The HDD 304 has a function as a storage area and stores an application program for executing various types of processing and the like. It should be noted that the HDD 304 is an example of a storage device. The storage device can be configured using a solid state drive (SSD) or the like instead of the HDD 304. The communication unit 305 is an interface configured to connect various devices to each application. The chat server 300 communicates with the PC 400, the MFP 200, and the like via the network 100 under the control of the CPU 301.

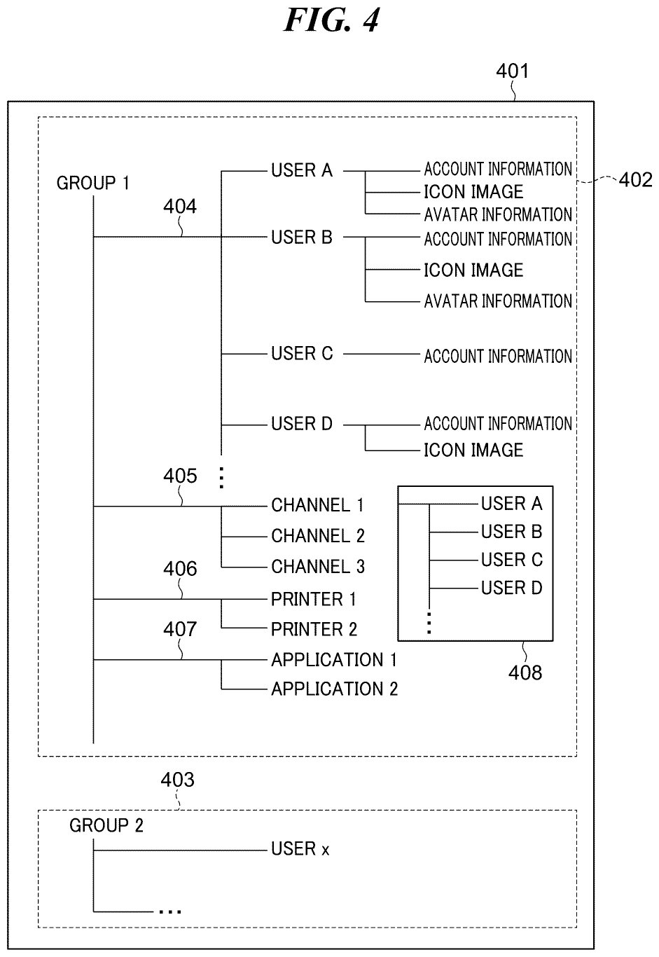

FIG. 4 is a diagram showing an example of a file structure 401 stored in the HDD 304 of the chat server 300 of FIG. 1. The file structure 401 includes one or more pieces of group information. In the example shown in FIG. 4, there are two pieces of group information 402 and 403, but one file structure may include only one piece of group information.

The group information 402 includes information regarding Group 1. The group information 403 includes information regarding Group 2. It should be noted that the group information 402 and the group information 403 have similar configurations in the present embodiment. Hereinafter, the configuration of the group information 402 will be described as an example. The group information 402 includes user information 404, channel information 405, printer information 406, and cooperative application information 407.

The user information 404 is information of a user belonging to Group 1. For example, the user information 404 includes, as information of a user A belonging to Group 1, account information of the user A, an icon image of the user A, and avatar information of the user A. The account information of the user A is account information of the user A registered in the chat server 300. The icon image of the user A is an image in which the user A can be identified, and is, for example, an image including one initial of the user A. The avatar information of the user A is information for displaying an avatar image created by the user A, the avatar image three-dimensionally expressing the user A. It should be noted that creation of an avatar image and a configuration of avatar information will be described later.

The channel information 405 is information for grouping the user information 404, and holds a user list in which corresponding users are organized for each channel. For example, the channel information 405 holds a user list 408 including the user A, a user B, a user C, a user D, and the like. The printer information 406 indicates device information of the MFP 200. An application using the group information 402 can refer to the printer information 406 to send various commands to any MFP.

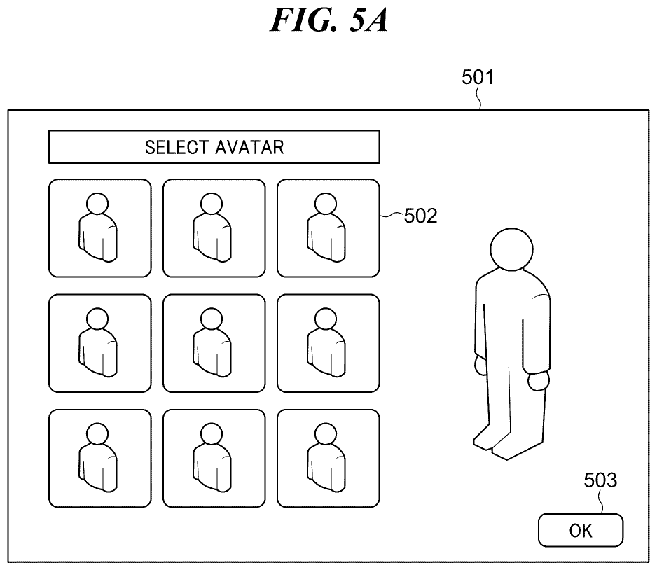

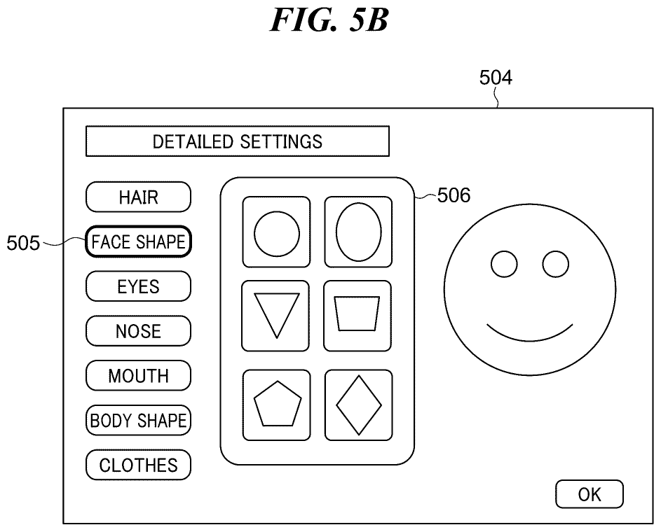

FIGS. 5A and 5B are diagrams showing examples of screens when a user creates his/her own avatar. The user can access the chat server 300 from the PC 400 or the like to create his/her own avatar.

FIG. 5A shows an example of a base selection screen 501. The base selection screen 501 is a screen for allowing the user to select a base of the avatar. The user selects one base, for example, a base 502 from among a plurality of bases displayed on the base selection screen 501, and presses an OK button 503 to determine the base of the avatar.

FIG. 5B shows an example of a detailed setting screen 504. The detailed setting screen 504 is a screen configured to make detailed settings with respect to the determined base. The user can customize a hairstyle, a contour, eyes, a body shape, clothes, and the like in detail. FIG. 5B shows, as an example, the detailed setting screen 504 when the user presses a face shape selection button 505. The user can select a desired face shape from among listed face shape patterns 506.

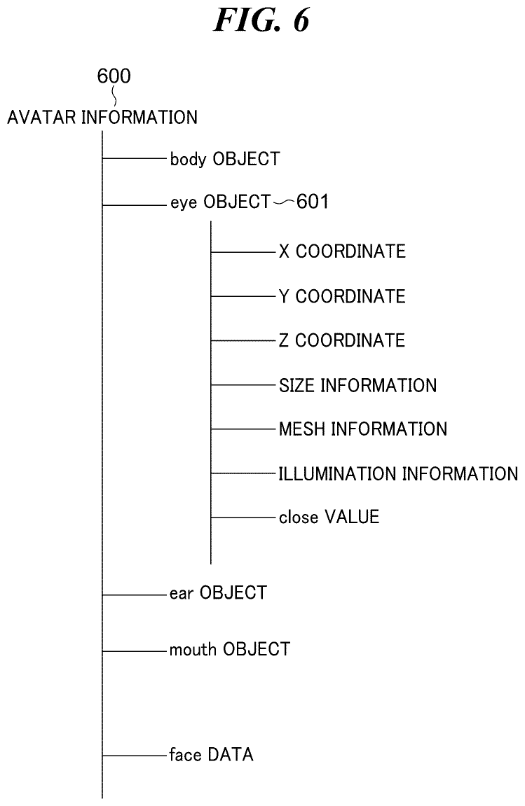

FIG. 6 is a diagram showing a configuration example of avatar information 600 included in the file structure 401 of FIG. 4. The avatar information 600 includes a plurality of objects, and each of the objects includes various types of information. For example, an eye object 601 includes x, y, and z coordinate information indicating the distance from the center of an avatar image, size information indicating a size of an object, mesh information indicating the appearance of eyes, illumination information indicating the angle and intensity of light, a close value indicating a degree of closing of eyes, and the like. When the close value is the maximum value, that is, 100, it indicates a state in which the eyes are closed. The face information indicates data of a default avatar face. The use of the avatar information 600 often enables reproduction of an avatar image in a server, a PC, or the like other than the chat server 300. In the present embodiment, a plurality of pieces of the avatar information 600 corresponding to a plurality of facial expressions may be registered in advance, or the avatar information 600 may be dynamically generated in cooperation with the chat server 300 or a server (not shown).

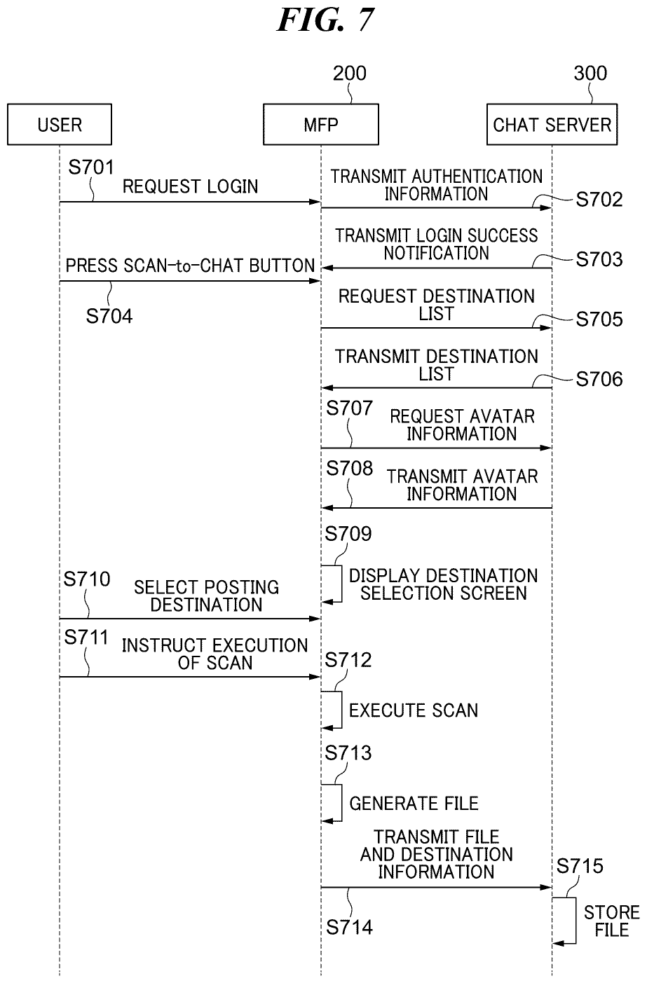

FIG. 7 is a diagram showing an example of a sequence of scan-to-chat executed by the system of FIG. 1. The “scan-to-chat” is a function for sharing image data generated by a scan on a chat. In the present embodiment, a case where a user not shown in FIG. 4, the user being included in the user list 408 held in the channel information 405 uses the scan-to-chat will be described as an example. Hereinafter, the user who uses the scan-to-chat and performs an operation is referred to as an “operating user”.

In FIG. 7, the operating user first requests the MFP 200 to log in the chat server 300 (S701), where “S” means a step. Specifically, the operating user inputs authentication information such as a user name and a password for logging in to the chat server 300 to the operation unit 205 of the MFP 200. The MFP 200 transmits the input authentication information to the chat server 300 (S702).

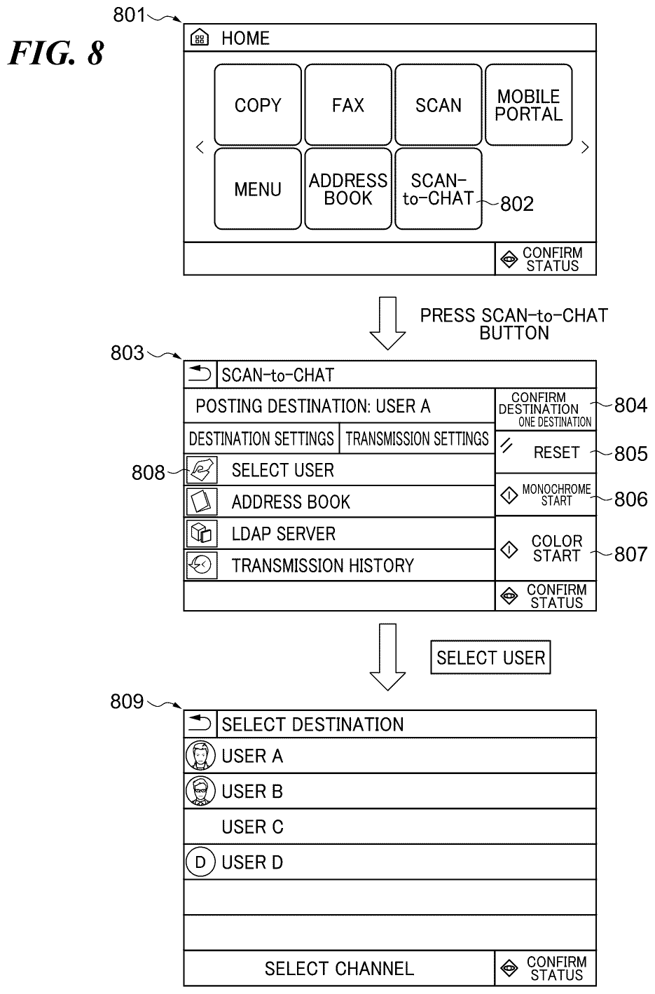

The chat server 300 performs user authentication using the received authentication information. When the user authentication is successful, the chat server 300 transmits a login success notification to the MFP 200 (S703). When the MFP 200 receives the login success notification, a scan-to-chat execution button 802, which has been grayed out not to be selectable, becomes selectable on a home screen 801 (FIG. 8) displayed on the operation unit 205. It should be noted that a configuration in which control is performed such that the operating user cannot perform an operation of selecting the scan-to-chat execution button 802 until the MFP 200 receives the login success notification is described in the present embodiment, but the present invention is not limited to this configuration. For example, a configuration in which the scan-to-chat execution button 802 is additionally displayed on the home screen 801 in response to the MFP 200 receiving the login success notification may be adopted.

When the operating user presses the scan-to-chat execution button 802 (S704), the MFP 200 causes the operation unit 205 to display a scan-to-chat screen 803. The scan-to-chat screen 803 includes a destination confirmation button 804, a reset button 805, a monochrome start button 806, a color start button 807, and a user selection button 808.

The destination confirmation button 804 displays the number of destinations selected and set as posting destinations (sharing destinations) of image data generated by a scan. In the example of FIG. 8, one posting destination is set. In a case where a plurality of posting destinations is set, the number of the set posting destinations is displayed as the number of destinations on the destination confirmation button 804. The reset button 805 is a button for instructing clearing of the set destination. The monochrome start button 806 is a button for instructing the start of monochrome scan and transmission processing. In the monochrome scan and transmission processing, the MFP 200 reads an image of a set document, generates monochrome image data based on the read image, and transmits the generated monochrome image data to the set destination. The color start button 807 is a button for instructing the start of color scan and transmission processing. In the color scan and transmission processing, the MFP 200 reads the image of the set document, generates color image data based on the read image, and transmits the generated color image data to the set destination. The user selection button 808 is a button for instructing a display of a destination selection screen 809.

Next, the MFP 200 requests the chat server 300 for a destination list that is information on a list of destination candidate users (S705). The chat server 300 acquires the user list 408 including the destination candidate users from the channel information 405 of the file structure 401 stored in the HDD 304. The chat server 300 transmits the acquired user list 408 to the MFP 200 as the destination list (S706).

The MFP 200 requests the chat server 300 for the avatar information 600 of users indicated by the acquired user list 408 (S707). The chat server 300 transmits the avatar information 600 of the users corresponding to the request received from the MFP 200 to the MFP 200 from the file structure 401 stored in the HDD 304 (S708).

Thereafter, when the operating user selects the user selection button 808, the MFP 200 causes the operation unit 205 to display the destination selection screen 809 of FIG. 8 based on the received avatar information 600 (S709). Display control of the destination selection screen 809 will be described later. It should be noted that the MFP 200 may hold the acquired avatar information 600 in the storage 204 in the present embodiment. Further, in the present embodiment, the operating user may set in advance the necessity of acquisition of the avatar information 600 on a setting screen (not shown), and the MFP 200 may control the presence or absence of acquisition of the avatar information 600 based on the setting.

Next, the operating user selects a posting destination (destination) on the destination selection screen 809 (S710), and instructs execution of a scan (S711). The MFP 200 receives the instruction for execution of a scan, and executes the scan in accordance with the received instruction (S712). The MFP 200 generates a file including the image data based on the read document image (S713), and transmits the generated file and destination information indicating the posting destination selected on the destination selection screen 809 to the chat server 300 (S714).

The chat server 300 stores the received file in a file storage area (not shown) provided for each destination user or each channel (S715). Thereafter, the sequence of FIG. 7 ends.

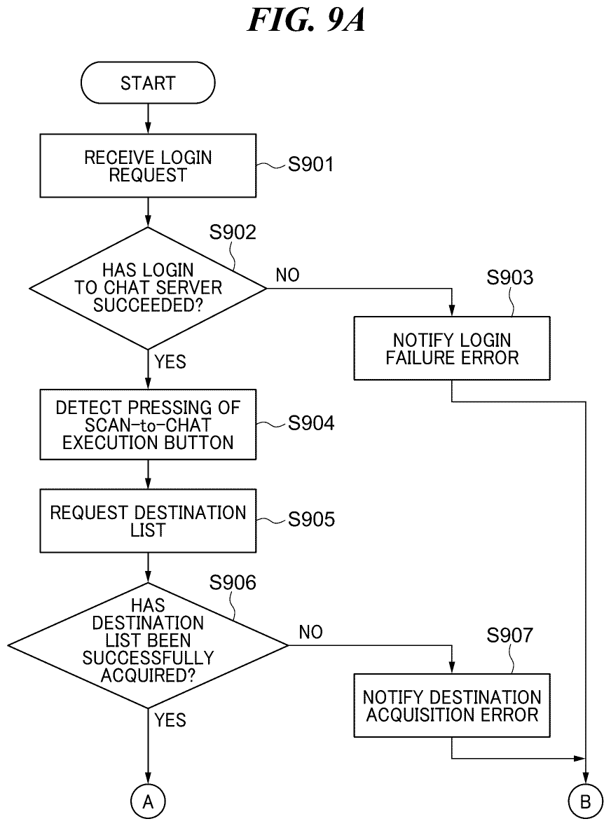

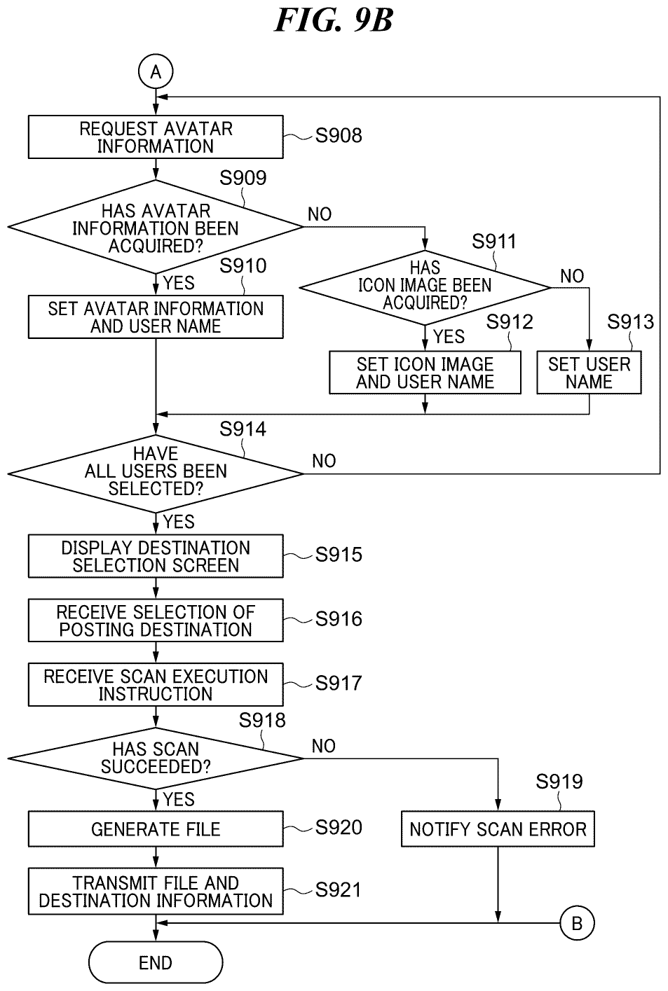

FIGS. 9A and 9B indicate a flowchart showing a procedure of control processing performed by the MFP 200 when the system of FIG. 1 executes the scan-to-chat. The control processing of FIGS. 9A and 9B is implemented as the CPU 201 of the MFP 200 executes a program stored in the ROM 202 or the storage 204. It should be noted that a case where a user (operating user) not shown in FIG. 4, the user being included in the user list 408 held in the channel information 405 uses the scan-to-chat will be described as an example also in FIGS. 9A and 9B similarly to FIG. 7.

In FIG. 9A, the CPU 201 receives a login request for the chat server 300 from the operating user (S901). As described above, the operating user inputs authentication information for logging in to the chat server 300 to the operation unit 205 of the MFP 200 to make the login request. The CPU 201 transmits the authentication information input to the operation unit 205 to the chat server 300. The chat server 300 performs user authentication using the received authentication information. The chat server 300 transmits a login success notification to the MFP 200 in a case where the authentication has succeeded, and transmits a login failure notification to the MFP 200 in a case where the authentication has failed.

The CPU 201 determines whether or not the login to the chat server 300 has succeeded (S902). In S902, it is determined that the login to the chat server 300 has succeeded in a case where the login success notification is received from the chat server 300, and it is determined that the login to the chat server 300 has failed in a case where the login failure notification is received from the chat server 300.

In a case where it is determined in S902 that the login to the chat server 300 has failed, the CPU 201 notifies a login failure error (S903). Specifically, the CPU 201 causes the operation unit 205 to display an error message indicating that the login to the chat server 300 has failed. Thereafter, the control processing of FIGS. 9A and 9B ends.

In a case where it is determined in S902 that the login to the chat server 300 has succeeded, the CPU 201 controls the scan-to-chat execution button 802 to be selectable on the home screen 801 displayed on the operation unit 205. Next, when detecting that the operating user has pressed the scan-to-chat execution button 802 (S904), the CPU 201 causes the operation unit 205 to display the scan-to-chat screen 803. Furthermore, the CPU 201 requests the chat server 300 for a destination list (S905). The chat server 300 that has received this request acquires the user list 408 including destination candidate users from the file structure 401 stored in the HDD 304, and transmits the acquired user list 408 to the MFP 200 as the destination list.

Next, the CPU 201 determines whether or not the destination list has been successfully acquired from the chat server 300 (S906). In a case where it is determined in S906 that the acquisition of the destination list from the chat server 300 has failed, the CPU 201 notifies a destination acquisition error (S907). Specifically, the CPU 201 causes the operation unit 205 to display an error message indicating that the acquisition of the destination list has failed. Thereafter, the control processing of FIGS. 9A and 9B ends.

In a case where it is determined in S906 that the acquisition of the destination list from the chat server 300 has succeeded, the CPU 201 selects one of a plurality of users indicated in the acquired destination list. Next, the CPU 201 requests the chat server 300 for the avatar information 600 of the selected user (S908). It should be noted that a configuration in which the request is made for the avatar information 600 of the user selected from the users indicated in the destination list has been described in the present embodiment, but the present invention is not limited to this configuration. For example, it may be configured to request a batch of a plurality of pieces of the avatar information 600 respectively corresponding to the users indicated in the destination list. Alternatively, it may be configured to request both the destination list and the avatar information 600 in S905. Alternatively, a configuration in which only the avatar information 600 or only an icon image is requested according to a setting by the user may be adopted.

Next, the CPU 201 determines whether or not the avatar information 600 of the selected user has been acquired (S909). In a case where it is determined in S909 that the avatar information 600 of the selected user has been acquired, the CPU 201 sets the acquired avatar information 600 and a user name of the selected user as display information of the selected user (S910). Next, the control processing of FIGS. 9A and 9B proceeds to S914 to be described later.

In a case where it is determined in S909 that the avatar information 600 of the selected user has not been acquired, the control processing of FIGS. 9A and 9B proceeds to S911. In the present embodiment, the chat server 300 transmits an icon image of the selected user to the MFP 200 in a case where the avatar information 600 of the selected user is not registered in the chat server 300.

In S911, the CPU 201 determines whether or not the icon image of the selected user has been acquired. In a case where it is determined in S911 that the icon image of the selected user has been acquired, the CPU 201 sets the acquired icon image and the user name of the selected user as display information of the selected user (S912). Next, the control processing of FIGS. 9A and 9B proceeds to S914 to be described later.

In a case where it is determined in S911 that the icon image of the selected user has not been acquired, the CPU 201 sets the user name of the selected user as display information of the selected user (S913). Next, the CPU 201 determines whether or not all the users indicated in the destination list have been selected (S914).

In a case where it is determined in S914 that any one of the users indicated in the destination list has not been selected (that is, it is not in a state in which “all the users indicated in the destination list have been selected”), the CPU 201 selects the next user from the users indicated in the destination list, and returns the control processing of FIGS. 9A and 9B to S908. It should be noted that the CPU 201 may perform control so as not to select the operating user operating the MFP 200, that is, the user logging in to the MFP 200, from among the users indicated in the destination list in the present embodiment.

In a case where it is determined in S914 that all the users indicated in the destination list have been selected, the CPU 201 stands by until the operating user selects the user selection button 808. When the operating user selects the user selection button 808, the CPU 201 causes the operation unit 205 to display the destination selection screen 809 of FIG. 8 based on the display information of each of the users set in some or all of the processes in S910 to S913 (S915).

On the destination selection screen 809, avatar images of the user A and the user B are displayed in association with the user A and the user B for which pieces of the avatar information 600 are registered in the chat server 300, respectively. Furthermore, on the destination selection screen 809, only a user name of the user C is displayed for the user C for which the avatar information 600 and an icon image are not registered in the chat server 300. Further, on the destination selection screen 809, an icon image of the user D is displayed in association with the user D for which only an icon image out of the avatar information 600 and the icon image is registered in the chat server 300. When the operating user selects a posting destination on the destination selection screen 809, a screen of the operation unit 205 is switched to the scan-to-chat screen 803.

When receiving selection of the posting destination from the operating user on the destination selection screen 809 (S916), the CPU 201 switches the screen of the operation unit 205 to the scan-to-chat screen 803. Thereafter, when receiving a scan execution instruction given by the operating user pressing the monochrome start button 806 or the color start button 807 on the scan-to-chat screen 803 (S917), the CPU 201 controls the reading unit 207 to start a scan of a set document. Next, the CPU 201 determines whether or not the scan has succeeded (S918).

In a case where it is determined in S918 that the scan has failed, the CPU 201 notifies a scan error (S919). Specifically, the CPU 201 causes the operation unit 205 to display an error message indicating that the scan has failed. Thereafter, the control processing of FIGS. 9A and 9B ends.

In a case where it is determined in S918 that the scan has succeeded, the CPU 201 generates a file including image data based on an image of the read document (S920). Next, the CPU 201 transmits the generated file and destination information indicating the posting destination selected in S916 to the chat server 300 (S921), and ends this processing.

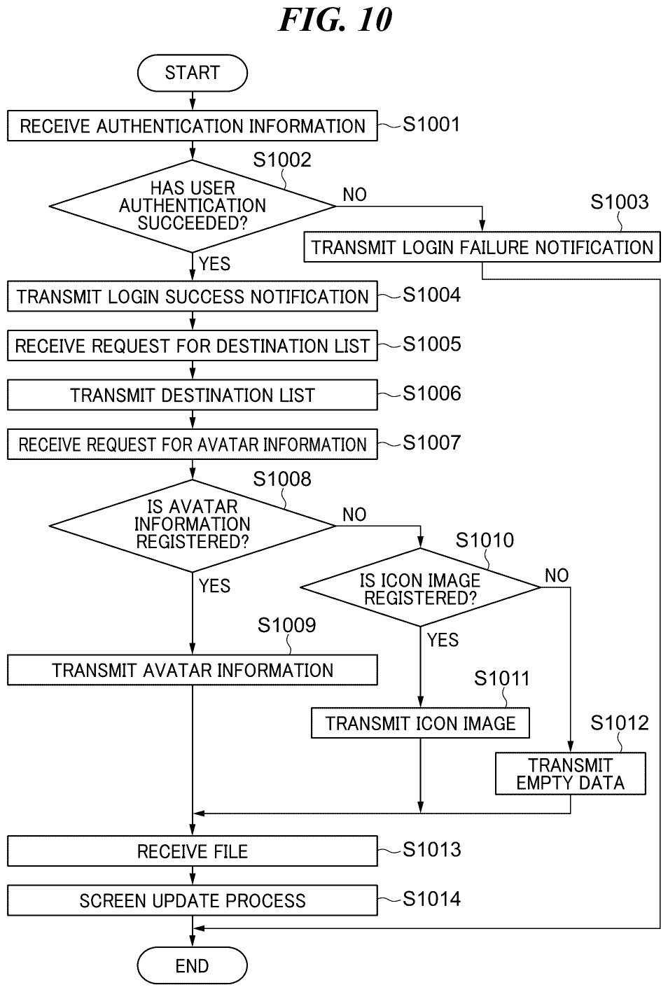

FIG. 10 is a flowchart showing a procedure of control processing performed by the chat server 300 when the system of FIG. 1 executes the scan-to-chat. The control processing of FIG. 10 is implemented as the CPU 301 of the chat server 300 executes a program stored in the ROM 302 or the HDD 304.

In FIG. 10, when receiving authentication information from the MFP 200 (S1001), the CPU 301 performs user authentication in which the received authentication information is collated with registered user information (not shown) stored in the HDD 304. The CPU 301 determines whether or not the user authentication has succeeded (S1002).

In a case where it is determined in S1002 that the user authentication has failed, the CPU 301 transmits a login failure notification to the MFP 200 (S1003), and ends this processing. In a case where it is determined in S1002 that the user authentication has succeeded, the CPU 301 transmits a login success notification to the MFP 200 (S1004). Next, when receiving a request for a destination list from the MFP 200 (S1005), the CPU 301 transmits the destination list to the MFP 200 based on user information received from the MFP 200 together with the request, the information indicating an operating user who has instructed the request (S1006). In step S1006, the CPU 301 acquires a user list including destination candidate users from the channel information 405 of the file structure 401 stored in the HDD 304, and transmits the acquired user list to the MFP 200.

Next, when receiving a request for the avatar information 600 from the MFP 200 (S1007), the CPU 301 starts a process of searching the file structure 401 for the avatar information 600 of the user corresponding to the received request. The CPU 301 determines whether or not the avatar information 600 of the user corresponding to the received request is registered in the file structure 401 (S1008).

In a case where it is determined in S1008 that the avatar information 600 of the user corresponding to the received request is registered in the file structure 401, the CPU 301 acquires the corresponding avatar information 600 from the file structure 401. Then, the CPU 301 transmits the acquired avatar information 600 to the MFP 200 (S1009). Next, the control processing of FIG. 10 proceeds to S1013 to be described later.

In a case where it is determined in S1008 that the avatar information 600 of the user corresponding to the received request is not registered in the file structure 401, the CPU 301 starts a process of searching the file structure 401 for an icon image of the user corresponding to the received request. The CPU 301 determines whether or not the icon image of the user corresponding to the received request is registered in the file structure 401 (S1010).

In a case where it is determined in S1010 that the icon image of the user corresponding to the received request is registered in the file structure 401, the CPU 301 acquires the corresponding icon image from the file structure 401. Then, the CPU 301 transmits the acquired icon image to the MFP 200 (S1011). Next, the control processing of FIG. 10 proceeds to S1013 to be described later.

In a case where it is determined in S1010 that the icon image of the user corresponding to the received request is not registered in the file structure 401, the CPU 301 transmits empty data to the MFP 200 (S1012). It should be noted that the CPU 301 may transmit a default image registered in advance to the MFP 200 in S1012.

Next, when receiving a file from the MFP 200 (S1013), the CPU 301 stores the file in a predetermined folder corresponding to destination information received together with the file. Next, the CPU 301 performs a screen update process of displaying this file on the scan-to-chat screen 803 (S1014), and ends this processing.

According to the above-described embodiment, an avatar image of a user is displayed on the destination selection screen 809 in association with the user who is a candidate for a posting destination of image data. As a result, the operating user can easily specify the posting destination of the image data.

Furthermore, in the above-described embodiment, in a case where the avatar information 600 of the user as the candidate for the posting destination of the image data is not registered in the chat server 300, an icon image of the user is displayed on the destination selection screen 809 in association with the user as the candidate for the posting destination of the image data. As a result, the operating user can specify the posting destination of the image data from the icon image.

It should be noted that an avatar image in which whether the user as the candidate for the posting destination is in an online state or an offline state can be identified may be displayed in the present embodiment. Here, the avatar information 600 often includes morphing information capable of controlling blinking, opening and closing of a mouth, movements of eyes, and the like, such as the close value of FIG. 6. By controlling such morphing information, it is possible to display the avatar information 600 with various facial expressions on the destination selection screen 809. Hereinafter, a configuration in which the chat server 300 transmits, to the MFP 200, the avatar information 600 for displaying an avatar image in which the fact that the user as the candidate for the posting destination is in the offline state can be identified will be described.

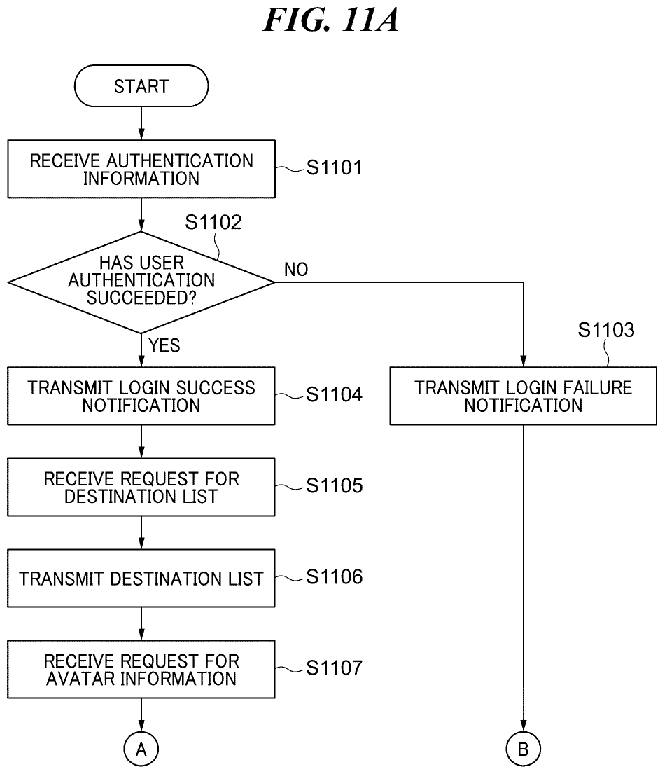

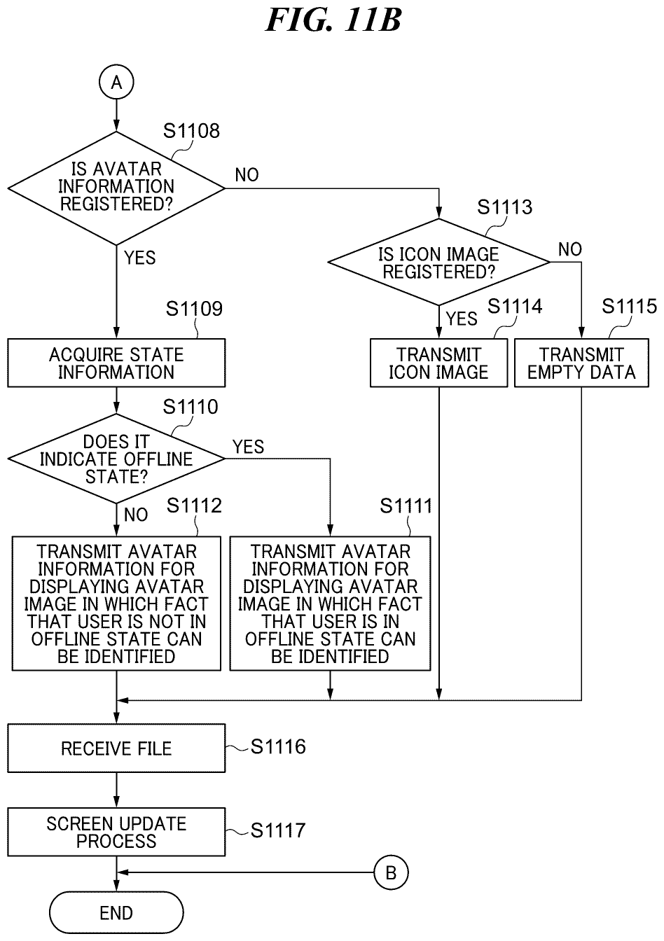

FIGS. 11A and 11B indicate a flowchart showing another procedure of the control processing performed by the chat server 300 when the system of FIG. 1 executes the scan-to-chat. The control processing of FIGS. 11A and 11B is processing similar to the control processing of FIG. 10 described above. Therefore, the content different from the above-described control processing of FIG. 10 will be particularly described hereinafter. Similarly to the control processing of FIG. 10 described above, the control processing of FIGS. 11A and 11B is also implemented as the CPU 301 of the chat server 300 executes a program stored in the ROM 302 or the HDD 304.

In FIGS. 11A and 11B, the CPU 301 performs S1101 to S1108 which are processes similar to S1001 to S1008.

In a case where it is determined in S1108 that the avatar information 600 of the user corresponding to the request received in S1107 is not registered in the file structure 401, the CPU 301 performs S1113 to S1117, which are processes similar to S1010 to S1014 described above, and ends the control processing of FIGS. 11A and 11B.

In a case where it is determined in S1108 that the avatar information 600 of the user corresponding to the request received in S1107 is registered in the file structure 401, the CPU 301 acquires state information indicating whether or not the user corresponding to the received request is in the offline state (S1109). Next, the CPU 301 determines whether or not the acquired state information indicates the offline state (S1110).

In a case where it is determined in S1110 that the acquired state information indicates the offline state, the CPU 301 transmits the avatar information 600 for displaying an avatar image in which the fact that the user is in the offline state can be identified to the MFP 200 (S1111). The avatar image in which the fact that the user is in the offline state can be identified is, for example, an avatar image in a state in which eyes are closed. In S1111, for example, the CPU 301 acquires the avatar information 600 of the user corresponding to the received request from the file structure 401, changes a close value of the eye object 601 of the acquired avatar information 600 to the maximum value, and transmits the edited avatar information 600 to the MFP 200. Alternatively, the CPU 301 acquires the avatar information 600 of the user corresponding to the received request, that is, the avatar information 600 in which the close value of the eye object 601 is set to the maximum value from the file structure 401, and transmits the acquired avatar information 600 to the MFP 200. Thereafter, S1116 and S1117, which are processes similar to S1013 and S1014 described above, are performed, and the control processing of FIGS. 11A and 11B ends.

In a case where it is determined in S1110 that the acquired state information does not indicate the offline state, the CPU 301 transmits the avatar information 600 for displaying an avatar image in which the fact that the user is not in the offline state can be identified to the MFP 200 (S1112). The avatar image in which the fact that the user is not in the offline state can be identified is, for example, an avatar image in a state in which eyes are opened. In S1112, for example, the CPU 301 acquires the avatar information 600 of the user corresponding to the received request from the file structure 401, changes the close value of the eye object 601 of the acquired avatar information 600 to a predetermined value at which eyes of an avatar are opened, and transmits the edited avatar information 600 to the MFP 200. Alternatively, the CPU 301 acquires the avatar information 600 of the user corresponding to the received request, that is, the avatar information 600 in which the close value of the eye object 601 is set to the predetermined value from the file structure 401, and transmits the acquired avatar information 600 to the MFP 200. Thereafter, S1116 and S1117, which are processes similar to S1013 and S1014 described above, are performed, and the control processing of FIGS. 11A and 11B ends.

In the above-described embodiment, an avatar image in which whether or not a user is in the offline state can be identified is displayed on the destination selection screen 809 based on the avatar information 600 received from the chat server 300. As a result, the operating user can know whether or not a posting destination of image data is in the offline state.

Furthermore, in the above-described embodiment, in a case where a user who is a candidate for a posting destination of image data is in the offline state, the MFP 200 acquires, from the chat server 300, the avatar information 600 for displaying an avatar image in which the fact that the user is in the offline state can be identified. Furthermore, in a case where the user who is the candidate for the posting destination of the image data is not in the offline state, the MFP 200 acquires, from the chat server 300, the avatar information 600 for displaying an avatar image in which the fact that the user is not in the offline state can be identified. As a result, the avatar image in which whether or not the user is in the offline state can be identified can be displayed on the destination selection screen 809 based on the avatar information 600 acquired from the chat server 300.

It should be noted that the MFP 200 may change the close value of the eye object 601 of the avatar information 600 acquired from the chat server 300 in the present embodiment. In such a configuration, the MFP 200 acquires state information indicating whether or not a user corresponding to the avatar information 600 is in the offline state at the time of acquiring the avatar information 600 from the chat server 300. For example, in a case where it is determined that the user is in the offline state based on the acquired state information, the MFP 200 performs control to change the close value of the eye object 601 of the avatar information 600 acquired from the chat server 300 to the maximum value. With such control, the MFP 200 can display an avatar image in which whether or not the user is in the offline state can be identified on the destination selection screen 809 regardless of what kind of facial expression the avatar information 600 acquired from the chat server 300 corresponds to.

Furthermore, a configuration in which an avatar image based on the avatar information 600 or an icon image is added to an icon displayed on a simple login screen for performing simple login may be adopted in the present embodiment.

The “simple login” is a function that enables login to the MFP 200 only by selecting an icon, which is displayed on the operation unit 205 and represents a user registered in advance, without inputting authentication information such as a user name and a password to the operation unit 205.

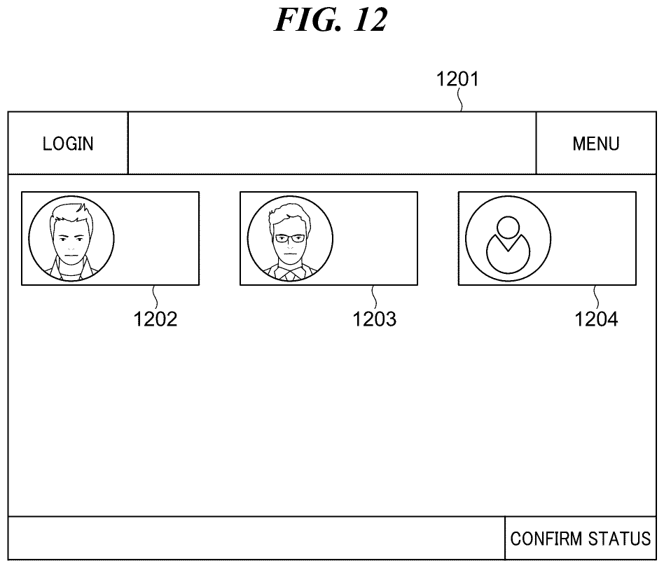

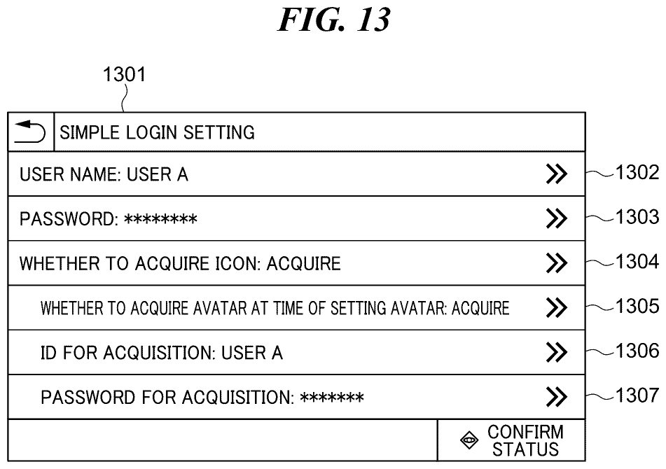

FIG. 12 is a diagram showing an example of a simple login screen 1201 displayed on the operation unit 205 of FIG. 2. Icons of the user A, the user B, and the user C are displayed on the simple login screen 1201. It should be noted that, on the simple login screen 1201, an avatar image based on the avatar information 600 registered in the chat server 300 is added to an icon 1202 of the user A and an icon 1203 of the user B. The default icon image prepared in advance is added to an icon 1204 of the user C for which the avatar information 600 is not registered in the chat server 300. In the present embodiment, the operating user can make settings related to the simple login screen 1201 through the setting screen 1301 of FIG. 13 displayed on the operation unit 205.

FIG. 13 is a diagram showing an example of the setting screen 1301 displayed on the operation unit 205 of FIG. 2. The setting screen 1301 is displayed by selecting a setting menu (not shown) displayed on the operation unit 205. On the setting screen 1301, a user name 1302, a password 1303, and a setting 1304 as to whether or not to acquire information to be added to an icon from the chat server 300 can be set. Hereinafter, the information to be added to the icon displayed on the simple login screen 1201 is referred to as “icon additional information”.

In a case where the setting 1304 is set to “acquire”, an avatar acquisition setting 1305, an ID for acquisition 1306, and a password for acquisition 1307 can also be set. The avatar acquisition setting 1305 is a setting indicating whether or not to acquire the icon additional information from the chat server 300 at the time of setting an avatar. The ID for acquisition 1306 is an identifier used to acquire the icon additional information from the chat server 300. The password for acquisition 1307 is a password used to acquire the icon additional information from chat server 300. In the present embodiment, the settings related to the simple login screen 1201 can be made for each user who is permitted to log in by the simple login on the setting screen 1301. That is, whether or not to add the information registered in the chat server 300 to the icon displayed on the simple login screen 1201 can be set for each icon. It should be noted that single sign-on may be used, and for example, login to the chat server 300 may also be performed by authentication of the login to the MFP 200.

The icon additional information may be acquired from the chat server 300 every time the simple login screen 1201 is displayed. Alternatively, the icon additional information acquired during the setting on the setting screen 1301 may be stored in the storage 204, and the icon additional information may be read from the storage 204 when the simple login screen 1201 is displayed.

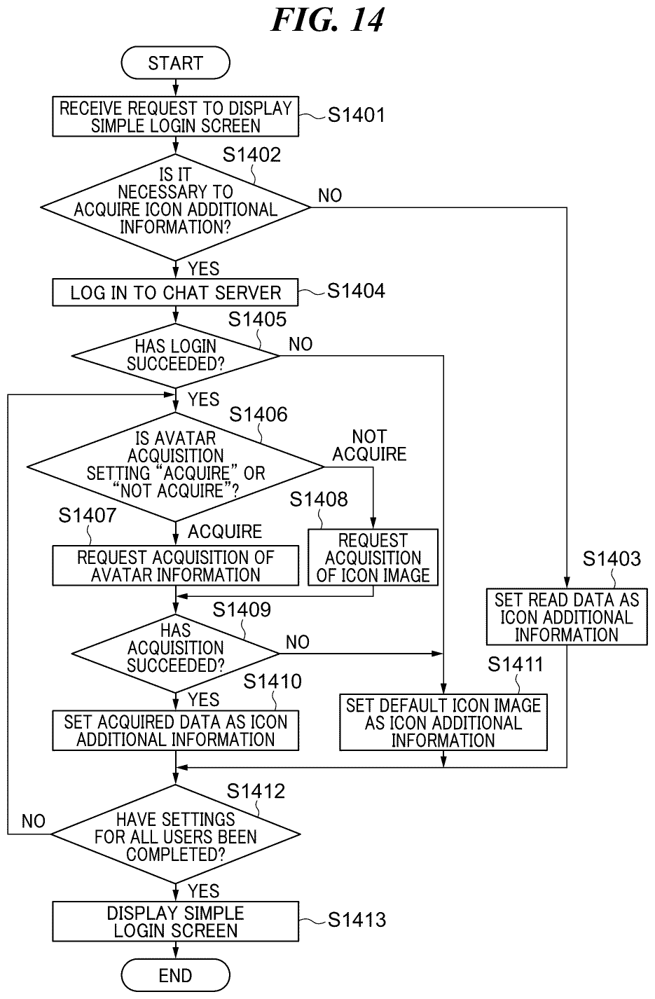

FIG. 14 is a flowchart showing a procedure of display control processing of the simple login screen performed by the MFP 200 of FIG. 1. The display control processing of FIG. 14 is implemented as the CPU 201 of the MFP 200 executes a program stored in the ROM 202 or the storage 204. It should be noted that it is assumed that the operating user has already made settings on the setting screen 1301 in the display control processing of FIG. 14.

In FIG. 14, when the CPU 201 receives a request to display the simple login screen 1201 from the operating user (S1401), the display control processing proceeds to S1402. In S1402, the CPU 201 determines whether or not it is necessary to acquire icon additional information from the chat server 300. In a case where the avatar information 600 or an icon image serving as the icon additional information is stored in the storage 204, it is determined that it is not necessary to acquire the icon additional information from the chat server 300. In this case, the CPU 201 reads the avatar information 600 or the icon image from the storage 204, and sets the read avatar information 600 or icon image as the icon additional information of a corresponding icon (S1403). Thereafter, the display control processing proceeds to S1412 to be described later.

In S1402, in a case where the avatar information 600 or the icon image serving as the icon additional information is not stored in the storage 204, it is determined that it is necessary to acquire the icon additional information from the chat server 300. In this case, the CPU 201 attempts to log in to the chat server 300 using pieces of information set in the ID for acquisition 1306 and the password for acquisition 1307 on the setting screen 1301 (S1404). Next, the CPU 201 determines whether or not the login to the chat server 300 has succeeded (S1405).

In a case where it is determined in S1405 that the login to the chat server 300 has succeeded, the CPU 201 selects one user from among users permitted to log in by the simple login. The CPU 201 determines whether the avatar acquisition setting 1305 on the setting screen 1301 corresponding to the selected user is “acquire” or “not acquire” (S1406).

In a case where it is determined in S1406 that the avatar acquisition setting 1305 is “acquire”, the CPU 201 requests the chat server 300 to acquire the avatar information 600 of the selected user (S1407). Next, the display control processing proceeds to S1409 to be described later.

In a case where it is determined in S1406 that the avatar acquisition setting 1305 is “not acquire”, the CPU 201 requests the chat server 300 to acquire the icon image of the selected user (S1408). Next, the display control processing proceeds to S1409. In S1409, the CPU 201 determines whether or not the acquisition of the avatar information 600 or the icon image has succeeded.

In a case where it is determined in S1409 that the acquisition of the avatar information 600 or the icon image has succeeded, the CPU 201 sets data acquired in S1407 or S1408 as the icon additional information of the selected user (S1410). Next, the display control processing proceeds to S1412 to be described later.

In a case where it is determined in S1405 that the login to the chat server 300 has failed and in a case where it is determined in S1409 that the acquisition of the avatar information 600 or the icon image has failed, the display control processing proceeds to S1411. In S1411, the CPU 201 sets a default icon image prepared in advance as the icon additional information of the selected user. Next, the CPU 201 determines whether or not settings of icons of all the users permitted to log in by the simple login have been completed (S1412).

In a case where it is determined in S1412 that a setting of an icon of any of the users permitted to log in by the simple login is not completed (that is, it is not in a state in which “settings of the icons of all the users permitted to log in by the simple login have been completed”), the CPU 201 selects the next user from among the users permitted to log in by the simple login. Thereafter, the display control processing returns to S1406.

In a case where it is determined in S1412 that the settings of the icons of all the users permitted to log in by the simple login have been completed, the CPU 201 causes the operation unit 205 to display the simple login screen 1201 (S1413). Thereafter, this processing ends.

In the above-described embodiment, whether or not to add an avatar image based on information acquired from the chat server 300 to an icon displayed on the simple login screen 1201 is set on the setting screen 1301. As a result, it is possible to easily specify a posting destination of image data based on the avatar information 600 managed by the chat server 300, and further, it is possible to easily specify which user the icon displayed on the simple login screen 1201 corresponds to.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-140965, filed Aug. 31, 2023, which is hereby incorporated by reference wherein in its entirety.

What is claimed is:

1. An image processing apparatus capable of communicating with a chat server that performs control to share received data with a designated user, the image processing apparatus comprising:
at least one memory that stores a set of instructions; and
at least one processor that executes the instructions, the instructions, when being executed, causing the image processing apparatus to:
read an image of a document and generate image data based on the image;
acquire, from the chat server, avatar information for displaying an avatar image three-dimensionally expressing a user who is a candidate for a sharing destination of the image data;
perform control to display a screen for designating the sharing destination of the image data; and
transmit the image data to be shared with the user designated on the screen to the chat server,
wherein the avatar image of the user who is the candidate for the sharing destination of the image data, which is an avatar image based on the acquired avatar information, is displayed on the screen in association with the user.

2. The image processing apparatus according to claim 1, wherein
the at least one processor further executes the instruction causing the image processing apparatus to acquire an icon image for identifying the user who is the candidate for the sharing destination of the image data from the chat server in a case where the avatar information for displaying the avatar image of the user is not registered in the chat server, and
the acquired icon image, which is an icon image of the user who is the candidate for the sharing destination of the image data, is displayed on the screen in association with the user.

3. The image processing apparatus according to claim 1, wherein
an avatar image with which whether or not the user who is the candidate for the sharing destination of the image data is in an offline state can be identified is displayed on the screen in association with the user.

4. The image processing apparatus according to claim 3, wherein
the at least one processor further executes the instruction causing the image processing apparatus to
acquire avatar information for displaying an avatar image with which a fact that the user who is the candidate for the sharing destination of the image data is in the offline state can be identified in a case where the user is in the offline state, and
acquire avatar information for displaying an avatar image with which a fact that the user who is the candidate for the sharing destination of the image data is not in the offline state can be identified in a case where the user is not in the offline state.

5. The image processing apparatus according to claim 3, wherein the at least one processor further executes the instruction causing the image processing apparatus to:
acquire state information indicating whether or not the user who is the candidate for the sharing destination of the image data is in the offline state; and
change a set value indicating a degree of closing of eyes included in the acquired avatar information.

6. The image processing apparatus according to claim 1, wherein
the at least one processor further executes the instruction causing the image processing apparatus to
set whether or not to add an avatar image based on information acquired from the chat server to a predetermined icon displayed on the screen, and
the predetermined icon is an icon for logging in to the image processing apparatus without inputting authentication information, and is an icon representing a user registered in advance.

7. A control method for an image processing apparatus capable of communicating with a chat server that performs control to share received data with a designated user, the control method comprising:
reading an image of a document and generating image data based on the image;
acquiring, from the chat server, avatar information for displaying an avatar image three-dimensionally expressing a user who is a candidate for a sharing destination of the image data;
performing control to display a screen for designating the sharing destination of the image data; and
transmitting the image data to be shared with the user designated on the screen to the chat server,
wherein the avatar image of the user who is the candidate for the sharing destination of the image data, which is an avatar image based on the acquired avatar information, is displayed on the screen in association with the user.

8. A non-transitory computer-readable storage medium storing a program for causing a computer to execute a control method for an image processing apparatus capable of communicating with a chat server that performs control to share received data with a designated user,
the control method comprising:
reading an image of a document and generating image data based on the image; acquiring, from the chat server, avatar information for displaying an avatar image three-dimensionally expressing a user who is a candidate for a sharing destination of the image data;
performing control to display a screen for designating the sharing destination of the image data; and
transmitting the image data to be shared with the user designated on the screen to the chat server,
wherein the avatar image of the user who is the candidate for the sharing destination of the image data, which is an avatar image based on the acquired avatar information, is displayed on the screen in association with the user.
